(19) United States
(12) Patent Application Publication
(10) Pub. No.: US 2026/0106944 A1
(43) Pub. Date: Apr. 16, 2026

(54) IMAGE READING APPARATUS AND CONTROL METHOD FOR IMAGE READING APPARATUS

(71) Applicant: SHARP KABUSHIKI KAISHA, Osaka (JP)

(72) Inventor: KENTO WASHIDA, Osaka (JP)

(21) Appl. No.: 19/350,250

(22) Filed: Oct. 6, 2025

(30) Foreign Application Priority Data
Oct. 10, 2024 (JP) 2024-177997

(51) Int. Cl. H04N 1/00

(52) U.S. Cl. CPC H04N 1/00824; H04N 1/00408; H04N 1/00477; H04N 1/00514; H04N 1/00806; H04N 2201/0094

(57) ABSTRACT

An image reading apparatus that executes a job involving reading of a document, the image reading apparatus including a detector capable of detection of the document placed on a document table, and one or more controllers that control display of a notification screen related to the detection of the document, wherein the one or more controllers control display of a first notification screen related to the detection of the document, depending on an operation history of a user or an apparatus status of the image reading apparatus, when an instruction to execute a job is received, if a size of the document is not set and the document is not detected by the detector.

### TECHNICAL FIELD

The disclosure relates to an image reading apparatus and the like.

### BACKGROUND ART

It is known that, when reading of an image is started in a state where a document size of a document placed on a document table is uncertain, a message indicating that the document size is uncertain is displayed to a user.

### SUMMARY

### Technical Problem

An object of the disclosure is to provide an image reading apparatus and the like capable of improving user operability in execution of a job involving detection of a document placed on a document table.

### Solution to Problem

In order to solve the above problem, an image reading apparatus according to the disclosure is an image reading apparatus that executes a job involving reading of a document, the image reading apparatus including a detector capable of detection of the document placed on a document table, and one or more controllers that control display of a notification screen related to the detection of the document, wherein the one or more controllers control display of a first notification screen related to the detection of the document, depending on an operation history of a user or an apparatus status of the image reading apparatus, when an instruction to execute a job is received, if a size of the document is not set and the document is not detected by the detector.

A control method of an image reading apparatus according to the disclosure is a control method of an image reading apparatus, the image reading apparatus including a detector capable of detection of a document placed on a document table and executing a job involving reading of the document, the control method including controlling display of a notification screen related to the detection of the document, depending on an operation history of a user or an apparatus status of the image reading apparatus, when an instruction to execute a job is received, if a size of the document is not set and the document is not detected by the detector.

### Advantageous Effects of Disclosure

According to the disclosure, it is possible to provide an image reading apparatus and the like capable of improving user operability in execution of a job involving detection of a document placed on a document table.

### BRIEF DESCRIPTION OF DRAWINGS

FIG. 1 is a diagram illustrating an overall configuration of an image reading apparatus according to a first embodiment.

FIG. 2 is a diagram illustrating a functional configuration of the image reading apparatus according to the first embodiment.

FIG. 3 is a flowchart illustrating a processing flow according to the first embodiment.

FIG. 4 is a flowchart illustrating a processing flow according to the first embodiment.

FIG. 5 is a diagram illustrating an operation example according to the first embodiment.

FIGS. 6A and 6B are diagrams illustrating an operation example according to the first embodiment.

FIGS. 7A and 7B are diagrams illustrating an operation example according to the first embodiment.

FIG. 8 is a diagram illustrating a functional configuration of an image reading apparatus according to a second embodiment.

FIG. 9 is a flowchart illustrating a processing flow according to the second embodiment.

FIG. 10 is a diagram illustrating an operation example according to the second embodiment.

FIG. 11 is a flowchart illustrating a processing flow according to a third embodiment.

FIG. 12A is a diagram illustrating an example of a setting information file for managing setting information, and FIG. 12B is a diagram illustrating an example of a user information management table for managing user information.

### DESCRIPTION OF EMBODIMENTS

Hereinafter, embodiments of the disclosure are described with reference to the drawings. The disclosure describes a multifunction peripheral, as one form of an image reading apparatus, that is capable of achieving jobs related to, for example, copying, printing, scanning, faxing, e-mail, and the like in one housing. Note that the image reading apparatus according to the disclosure is not limited in its configuration as long as the image reading apparatus includes a document table for reading a document and is configured to be able to output to (print on) a recording medium (sheet of paper) or the like an image resulting from reading the document placed on the document table. Note that the following embodiments are examples for describing the disclosure, and the technical contents of the inventions described in the claims are not limited to the following description.

Some image reading apparatuses such as multifunction peripherals include a document feeder that automatically conveys a document to be read to a reading unit, and a document table on which a document is placed and read. Some of such document feeders and document tables have a function of automatically detecting a placed document (document size) (automatic detection function), and can form an image on a recording medium (sheet of paper) having the same size as the placed document, for example, based on a detection result by the automatic detection function.

On the other hand, for example, when a document size is not set and a document is not detected at the time of execution of a job such as a copy job, a warning indicating that the document size is undetected may be issued by the automatic detection function.

The warning indicating that the document size is undetected is a useful function in a situation where the document is not actually placed by the user. However, for example, when a timing at which a user places a document on the document table is before the image reading apparatus is activated, or when a document having a document size smaller than a detectable document size such as a name card is placed on the document table, the automatic detection function may determine that the document size is undetected.

In this case, although the document is correctly placed on the document table, the warning indicating that the document size is undetected is displayed, which may hinder the user's operation.

The disclosure realizes an image reading apparatus that can avoid displaying a message indicating that the document size is undetected more than necessary and lead the user to perform an appropriate operation to make the user conscious of an operation in which an unnecessary warning is not displayed in the following embodiments.

### 1 First Embodiment

In a first embodiment, when receiving an instruction to execute a job, if size setting of a document that can be detected by a detector is not set and a result of detecting a document cannot be acquired from the detector, a notification screen related to the detection of the document is displayed depending on an operation history of a user or an apparatus status of the image reading apparatus.

### 1.1 Functional Configuration

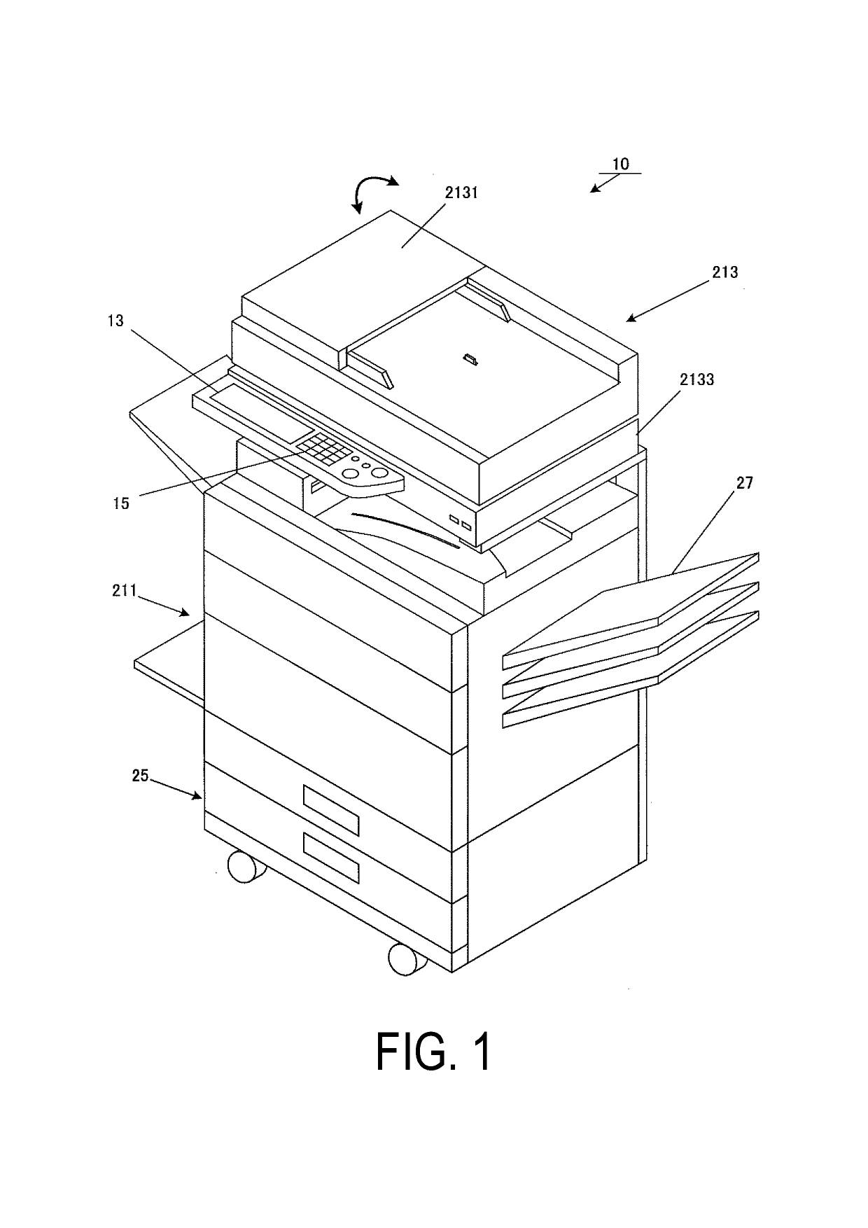

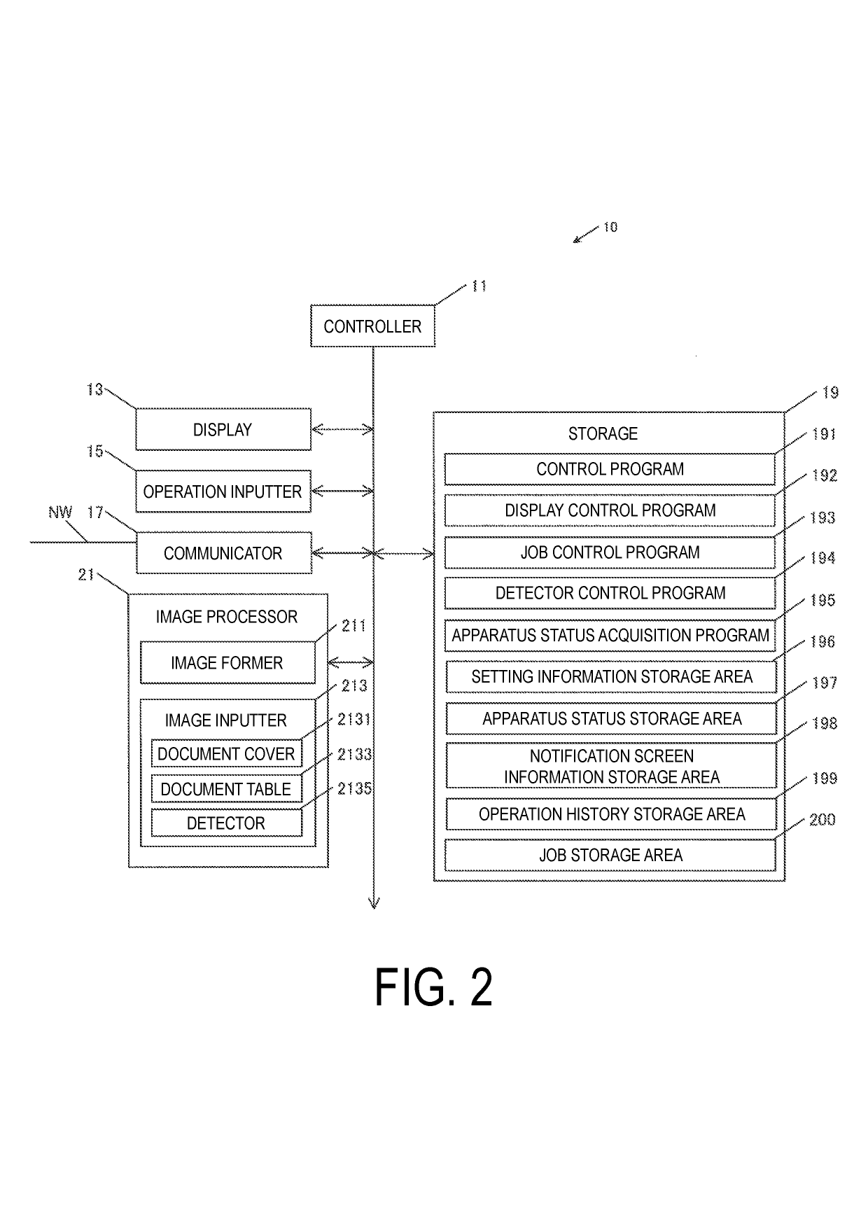

FIG. 1 is an external perspective view illustrating an overall configuration of a multifunction peripheral 10 as an image reading apparatus according to the first embodiment. FIG. 2 is a functional configuration diagram of the multifunction peripheral 10.

The multifunction peripheral 10 includes a controller 11, a display 13, an operation inputter 15, a communicator 17, a storage 19, and an image processor 21.

The controller 11 generally controls the multifunction peripheral 10. The controller 11 can include one or more processing apparatuses (for example, a central processing unit (CPU), a system on a chip (SoC), or the like). The controller 11 implements its functions by reading and executing various programs stored in the storage 19. Note that the controller 11 may include one or more control circuits.

The display 13 displays various types of information for a user. The display 13 can include, for example, a liquid crystal display (LCD) or an organic electro-luminescence (EL) display. The display 13 displays an operation screen (for example, a home screen (not illustrated), an execution screen related to setting and execution of each job) depending on a state of the multifunction peripheral 10, a notification screen including a warning described later, and the like.

The operation inputter 15 receives input of information from the user or the like. The operation inputter 15 can include, for example, various input apparatuses such as operation keys including hardware keys and software keys, and buttons. Note that the operation inputter 15 can also be configured as a touch panel that enables information to be input via the display 13. The operation inputter 15, when configured as a touch panel, can detect touch, tap, and swipe operations, or the like by the user on an object such as the operation key and operation button displayed via the display 13 to acquire coordinate information, pressure-sensitive information, and the like on the touch panel. An input method for the touch panel that can be employed includes a general method such as a resistance film method, an infrared beam method, an electromagnetic induction method, or an electrostatic capacitance method, for example.

The communicator 17 includes one or both of wired and wireless interfaces for communicating with another apparatus via a network NW such as a local area network (LAN), a wide area network (WAN), the Internet, a telephone line, or a fax line, for example. In addition, the communicator 17 may include an interface related to a (short-range) wireless communication technology such as Bluetooth (trade name), Near Field Communication (NFC), Wi-Fi (trade name), ZigBee (trade name), Infrared Data Association (IrDA), or a wireless USB.

The image processor 21 includes an image former 211 and an image inputter 213. The image former 211 feeds a sheet from a sheet feed tray 25, forms an output image (print image) on the sheet based on image data (data read from a document), and then discharges the sheet to a sheet discharge tray 27. The image former 211 can include, for example, a laser printer that employs an electrophotographic scheme. In this case, the image former 211 performs image formation using toners supplied from toner cartridges (not illustrated) corresponding to toner colors (for example, cyan, magenta, yellow, and black).

The image inputter 213 includes a document cover 2131, a document table 2133, and a detector 2135. The document cover 2131 as a cover member is connected to the document table 2133 via a hinge member (not illustrated) or the like, and is configured to be openable and closable in a direction depicted by an arrow in FIG. 1 with respect to the document table 2133. The document cover 2131 has an automatic document feeder (ADF) provided on an upper portion thereof, and a holding member (document mat) (not illustrated) holding a document placed on a contact glass provided on the document table 2133, the holding member being provided on a surface of the document cover 2131 facing (in contact with) the contact glass and having an area substantially the same as the contact glass.

The document table 2133 can be configured as a box-shaped member provided with a light source (not illustrated), the contact glass on which a document is placed, an image sensor configured to be movable in a longitudinal direction of the document table 2133, such as a charge coupled device (CCD) or a contact image sensor (CIS), and the like. The image sensor, which is provided at a position where a reflected light image of a light emitted from the light source to the document placed on the contact glass is formed, generates image data by reading the reflected light image.

The detector 2135 is a detection member that detects a document (document size) placed on the document table 2133. As the detector 2135, an optical or mechanical sensor member can be used, and a detection result by the detector 2135 is output as a detection signal to the controller 11. Note that the detector 2135 has detectable document sizes set in advance (for example, A3 size, B4 size, A4 size, B5 size, A5 size, ..., name card size, and direct input), and the document (document size) cannot be detected in some cases, for example, when the document size of the document placed on the document table 2133 is the name card size (or a size less than the name card size) or a size that requires direct input, when the document size is a size not conforming to the paper standard (JIS standard size), or because of the timing of the activation of the multifunction peripheral 10 or the like. On the other hand, when a document having a document size that can be detected by the detector 2135 is placed on the document table 2133 after the detector 2135 becomes able to detect the document (document size), and the document is detected by the detector 2135, the document size of the document is uniquely determined to be the document size that can be detected by the detector 2135. Therefore, in the disclosure, the description is made assuming that "the document size is not detected" is synonymous with "the document is not detected (undetected)", and "the document size is detected" is synonymous with "the document is detected".

Here, the image inputter 213 may include an interface that can acquire image data stored in a storage apparatus such as a USB memory and having a file format such as TIFF, BMP, and JPEG, and image data transmitted from an external terminal apparatus not illustrated. The image inputter 213 may be those subjecting the acquired image to, for example, shading correction or density correction to generate image data for data transmission.

The storage 19 is one or more storage apparatuses that store various programs and various types of data required for operation of the multifunction peripheral 10. The storage 19 can include a storage apparatus such as a random access memory (RAM), a solid state drive (SSD), a hard disk drive (HDD), and a read only memory (ROM).

In the first embodiment, the storage 19 stores a control program 191, a display control program 192, a job control program 193, a detector control program 194, and an apparatus status acquisition program 195, and secures a setting information storage region 196, an apparatus status storage region 197, a notification screen information storage region 198, an operation history storage region 199, and a job storage region 200.

The control program 191 is a program that the controller 11 reads when generally controlling the multifunction peripheral 10. The controller 11 having read the control program 191 controls driving of hardware such as the display 13, the operation inputter 15, the communicator 17, and the image processor 21.

The display control program 192 is a program that the controller 11 reads when controlling an output of the operation screen displayed on the display 13 or the operation inputter 15 configured as a touch panel (for example, a home screen (not illustrated), an execution screen related to setting and execution of each job), or the notification screen including a warning described later. The controller 11 having read the display control program 192 controls displaying of the display 13 (operation inputter 15).

The job control program 193 is a program that the controller 11 reads when executing various jobs such as a print operation job including a copy job and a print job, a scan job, a fax job, and an e-mail sending job. The controller 11 having read the job control program 193 sets an apparatus mode of the multifunction peripheral 10 to a job mode for executing each job (for example, a copy mode, a print mode, a scan mode, a fax mode, an e-mail sending mode, or the like), and executes a job for which an execution instruction is received.

The detector control program 194 is a program that the controller 11 reads when detecting a document placed on the document table 2133. The controller 11 having read the detector control program 194 controls driving of the detector 2135 to determine whether a document is placed on the document table 2133. The controller 11 having read the detector control program 194 may determine whether a document size of a document placed on the document table 2133 is detected by controlling the driving of the detector 2135.

The apparatus status acquisition program 195 is a program that the controller 11 reads when acquiring an apparatus status of the multifunction peripheral 10. Here, the apparatus status of the multifunction peripheral 10 may include information on capabilities, functions, and operating statuses of a sheet feeding apparatus, a sheet discharge apparatus, or a post-processing apparatus, and the like mounted as standard equipment or options on the multifunction peripheral 10. In the first embodiment, sheet information on the type, size, and the like of the sheet accommodated in the sheet feed tray 25 mounted as the sheet feeding apparatus in the multifunction peripheral 10 is treated as the apparatus status of the multifunction peripheral 10.

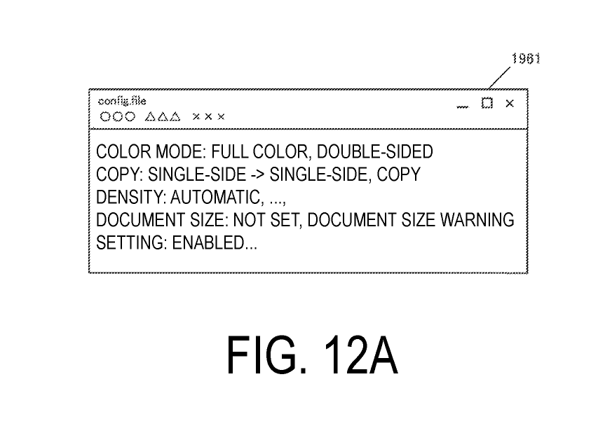

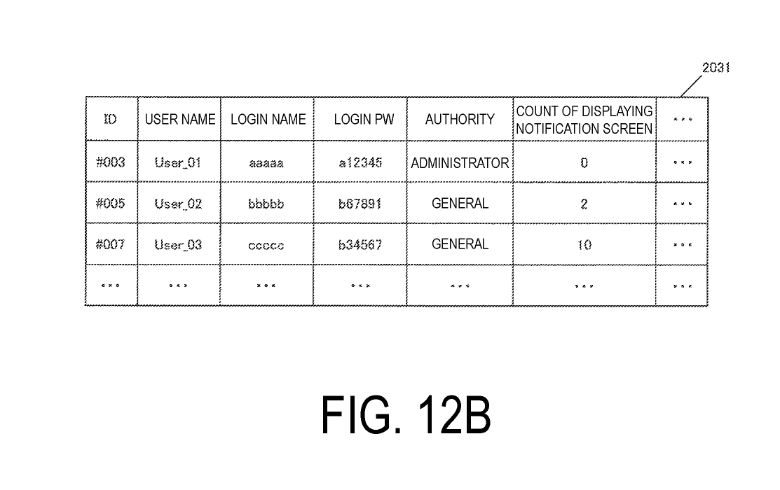

The setting information storage region 196 is a storage region that stores the apparatus setting information of the multifunction peripheral 10 or setting information required for execution of a job. Here, an example of the setting information stored in the setting information storage region 196 is described with reference to FIG. 12A.

FIG. 12A illustrates an example of a configuration of a setting information file 1961 for managing the setting information. The controller 11 can execute apparatus settings and jobs necessary for driving the apparatus by reading the setting information file 1961. The setting information file 1961 may be a file in a data format such as a text file, an XML file, or a JSON file, or may be binary data. FIG. 12A illustrates an example in which the setting information (setting items) mainly related to a copy job is managed as the setting information file 1961. Here, the document size, which is one of the setting items of the setting information file 1961, is an item related to the setting of the document size that can be detected by the detector 2135, and FIG. 12A illustrates that the setting of the document size is set to "not set". Document size warning setting is an item for enabling or disabling a notification setting of the notification screen or the like including a warning indicating that the document size is undetected, and FIG. 12A illustrates that the document size warning setting is set to "enabled". The controller 11 can set the document size warning setting to enable or disable by referring to the set value of the document size warning setting.

The apparatus status storage region 197 is a storage region that stores the apparatus status of the multifunction peripheral 10 acquired by the controller 11.

The notification screen information storage region 198 is a storage region that stores screen information such as a notification screen including a warning.

The operation history storage region 199 is a storage region that stores a history of user operations performed on the multifunction peripheral 10 (for example, opening and closing operations on the document cover 2131).

The job storage region 200 is a storage region that stores a job for which an instruction to execute is input by the user and an executed job as history information.

### 1.2 Processing Flow

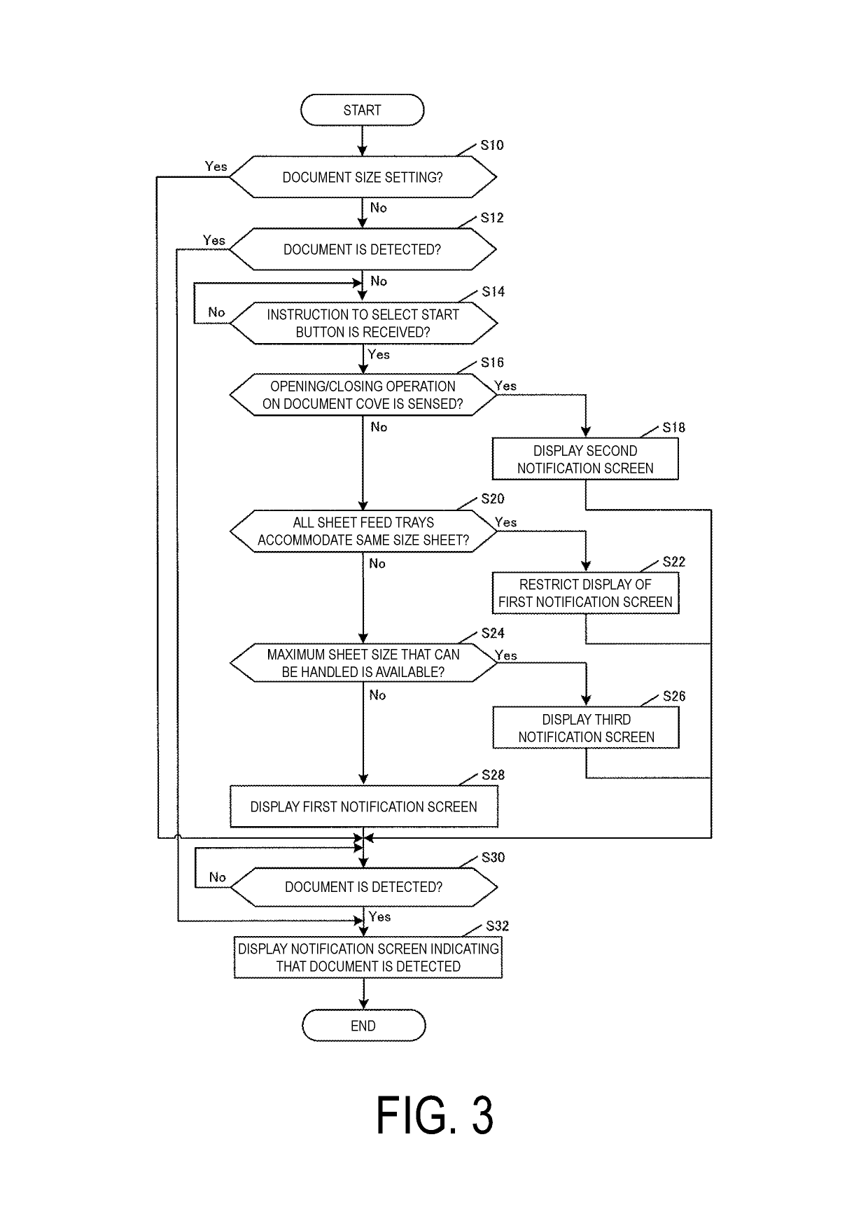

Next, a processing flow according to the first embodiment is described with reference to a flowchart illustrated in FIG. 3. The processing described in FIG. 3 is executed by the controller 11 of the multifunction peripheral 10 reading the control program 191, the display control program 192, the job control program 193, the detector control program 194, the apparatus status acquisition program 195, and the like.

Upon starting the processing, the controller 11 determines whether the setting of the document size is made for the document placed on the document table 2133 to be read (step S10).

When determining that the setting of the document size is made, the controller 11 progresses the processing to step S30 (step S10; Yes -> step S30). On the other hand, when determining that the setting of the document size is not made, the controller 11 determines whether the document (document size) is detected by the detector 2135 (step S10; No -> step S12). In this case, the controller 11 may determine whether the document (document size) is detected based on whether a detection signal is received from the detector 2135.

When determining that the document (document size) is detected by the detector 2135, the controller 11 progresses the processing to step S32 (step S12; Yes -> step S32). On the other hand, when determining that the document (document size) is not detected by the detector 2135, the controller 11 determines whether an instruction to select a start button by the user is received (step S12; No -> step S14).

When determining that the instruction to select the start button by the user is received, the controller 11 determines whether sensing of an opening/closing operation on the document cover 2131 by the user is stored as the operation history of the user (step S16).

When determining that the sensing of the opening/closing operation on the document cover 2131 by the user is stored, the controller 11 displays a second notification screen and progresses the processing to step S30 (step S16; Yes -> step S18 -> step S30). When the document cover 2131 is opened and closed, it is highly possible that a document is placed on the document table 2133. Nevertheless, since the document (document size) is undetected, the controller 11 estimates that a document (of a document size) undetectable by the detector 2135 is placed. The controller 11 displays a notification screen (second notification screen) including a warning prompting the user to change a document setting to a small document size such as a name card size.

On the other hand, when determining that the sensing of the opening/closing operation on the document cover 2131 by the user is not stored, the controller 11 determines whether sheets having the same size are accommodated in all the sheet feed trays 25 mounted in the multifunction peripheral 10, as the apparatus status of the multifunction peripheral 10 (step S16; No -> step S20).

When determining that sheets having the same size are accommodated in all the sheet feed trays 25 mounted in the multifunction peripheral 10, the controller 11 restricts the display of the first notification screen, and progresses the processing to step S30 (step S20; Yes -> step 22 -> step S30). When sheets having the same size are accommodated in all the sheet feed trays 25 mounted in the multifunction peripheral 10, the user can grasp an output size of a sheet for print output, and thus the controller 11 estimates that it is highly possible that the document setting according to the output size is made (the document having the document size according to the output size is placed). The controller 11 restricts the display of the first notification screen including the warning indicating that the document size is undetected.

On the other hand, when determining that sheets having the same size are not accommodated in all the sheet feed trays 25 mounted in the multifunction peripheral 10, the controller 11 determines whether the sheet feed trays 25 mounted in the multifunction peripheral 10 include the sheet feed tray 25 accommodating a sheet having a maximum size that the multifunction peripheral 10 is capable of handling, as the apparatus status of the multifunction peripheral 10 (step S20; No -> step S24).

When determining that the sheet feed trays 25 mounted in the multifunction peripheral 10 include the sheet feed tray 25 accommodating a sheet having the maximum size that the multifunction peripheral 10 is capable of handling, the controller 11 displays a third notification screen and progresses the processing to step S30 (step S24; Yes -> step S26 -> step S30). When the sheet feed trays 25 mounted in the multifunction peripheral 10 include the sheet feed tray 25 accommodating a sheet having the maximum size that the multifunction peripheral 10 is capable of handling, print output with the sheet of the maximum size is possible, and image loss does not occur. Therefore, the controller 11 displays the third notification screen including a warning indicating that the print output with the sheet of the maximum size is performed.

On the other hand, when determining that the sheet feed trays 25 mounted in the multifunction peripheral 10 do not include the sheet feed tray 25 accommodating a sheet having the maximum size that the multifunction peripheral 10 is capable of handling, the controller 11 displays the first notification screen including the warning indicating that the document size is undetected (step S24; No -> step S28). Note that when the instruction to select the start button is received, the reading of the document may be interrupted and the first notification screen may be displayed.

Then, the controller 11 determines whether the document is detected by the detector 2135 while the first notification screen is displayed (step S30). For example, when determining that the document is detected by the detector 2135 because the user places a document on the document table 2133 and so on while the first notification screen is displayed, the controller 11 displays a notification screen indicating that the document is detected and ends the processing (step S30; Yes -> step S32 -> end). On the other hand, when determining that the document is not detected by the detector 2135, the controller 11 waits until the document is detected by the detector 2135 (step S30; No).

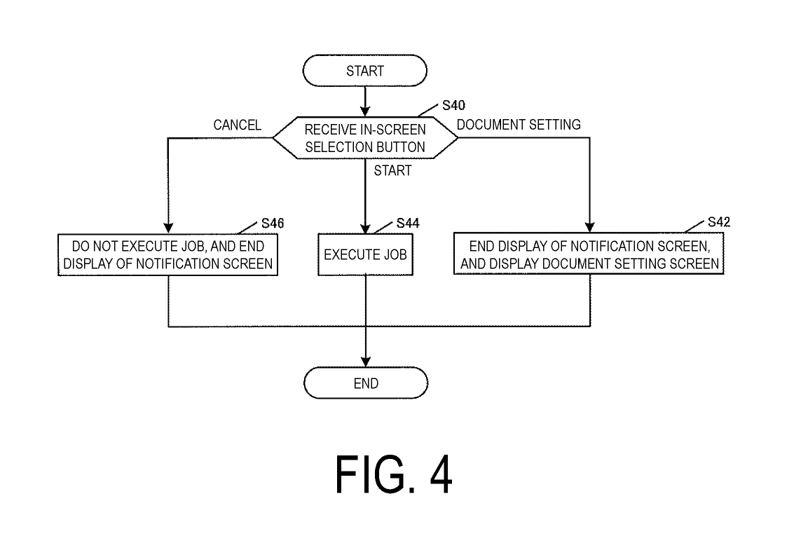

Next, a description is given of processing executed by the controller 11 based on an instruction to select an in-screen selection button such as a "document setting" button, a "start" button, or a "cancel" button provided on a notification screen (for example, the second notification screen) with reference to a flowchart of FIG. 4.

When receiving an instruction to select the "document setting" button provided on the notification screen, the controller 11 ends the display of the notification screen, displays the document setting screen, and ends the processing (step S40; "document setting" -> step S42 -> end).

On the other hand, when receiving an instruction to select the "start" button provided on the notification screen, the controller 11 executes the job and ends the processing (step S40 "start" -> step 44 -> end).

When receiving an instruction to select the "cancel" button provided on the notification screen, the controller 11 does not execute the job (cancels the execution of the job) and ends the display of the notification screen (step S40 "cancel" -> step S46 -> end).

Note that although the function of the in-screen selection button provided on the second notification screen has been described with reference to FIG. 4, the functions of the "start" button and the "cancel" button are common to the first and third notification screens.

### 1.3 Operation Example

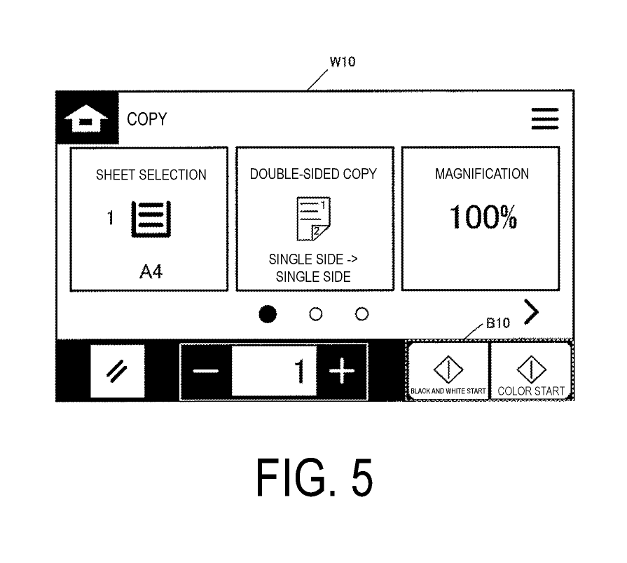

Next, an operation example according to the first embodiment is described. FIG. 5 illustrates an operation example corresponding to the processing related to step S14 in FIG. 3, and is an example of a configuration of a document reading start screen (copy screen) W10 displayed by the controller 11 when a copy job (copy function) is selected by the user on a home screen (not illustrated), for example.

The document reading start screen W10 includes a "start" button B10. The controller 11 determines whether an instruction to select the "start" button B10 by the user is received.

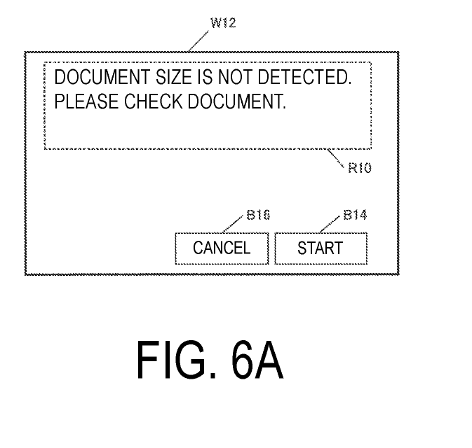

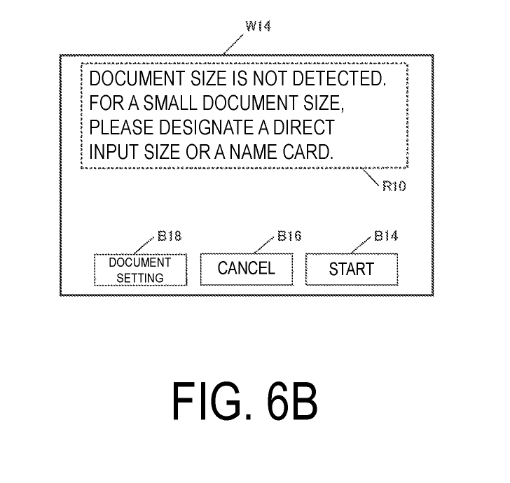

FIG. 6A illustrates an example of a configuration of a notification screen W12 as the first notification screen displayed in the step S28 or the like in FIG. 3. The notification screen W12 includes a notification content display region R10, a "start" button B14 as an in-screen selection button, and a "cancel" button B16.

The notification content display region R10 is a display region for displaying the notification content indicated as a notification on the notification screen W12. On the notification screen W12 as the first notification screen, the controller 11 displays a warning "Document size is not detected. Please check document." as the notification content in the notification content display region R10.

The "start" button B14 is an in-screen selection button for receiving an instruction to execute a job from the user. When receiving the instruction to select the "start" button B14, the controller 11 executes the job related to reading of the document. At this time, the controller 11 executes the job related to reading of the document with the document size of the document placed on the document table 2133 being set to the maximum size that the multifunction peripheral 10 is capable of handling. For example, when executing a copy job with the maximum size that the multifunction peripheral 10 is capable of handling being A3, the controller 11 reads the document placed on the document table 2133 as a document having a document size of A3, and performs printing on the sheet accommodated in the sheet feed tray that is displayed on the document reading start screen W10 at the time of receiving the instruction to select the "start" button B14, at the magnification that is displayed on the document reading start screen W10 at the time of receiving the instruction to select the "start" button B14. On the other hand, the "cancel" button B16 is an in-screen selection button for receiving an instruction to cancel execution of a jog. When receiving an instruction to select the "cancel" button B16, the controller 11 cancels the execution of the job and ends the display of the notification screen W12.

Next, FIG. 6B is an example of a configuration of a notification screen W14 as the second notification screen displayed in the step S18 of FIG. 3. The notification screen W14 includes a "document setting" button B18 in addition to the configuration of the notification screen W12. Note that in the description below, the same configurations are denoted by the same reference signs, and descriptions thereof may be omitted.

The notification content display region R10 is a display region for displaying the notification content indicated as a notification on the notification screen W14. On the notification screen W14 as the second notification screen, the controller 11 displays a warning prompting the user to change the document setting to a small document size such as a name card size, that is, "The document size is not detected. For a small document size, please designate a direct input size or a name card." as the notification content in the notification content display region R10.

The "document setting" button B18 is an in-screen selection button for receiving an instruction to change the document setting (document size) from the user. When receiving the instruction to select the "document setting" button B18, the controller 11 ends the display of the notification screen W14 and displays a document setting screen (not illustrated). Note that when the document size is selected/directly input on the document setting screen, the flow is "step S30; Yes -> step S32 -> end".

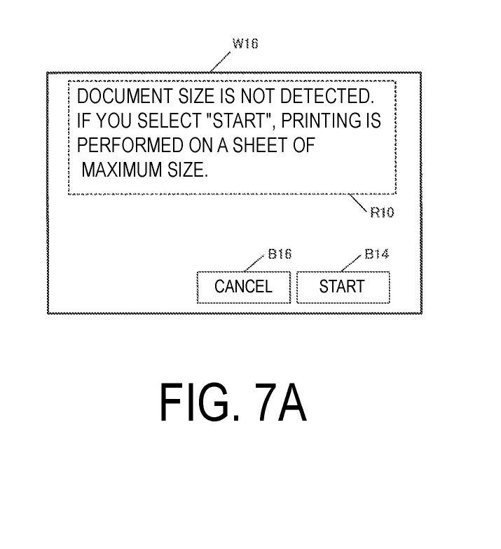

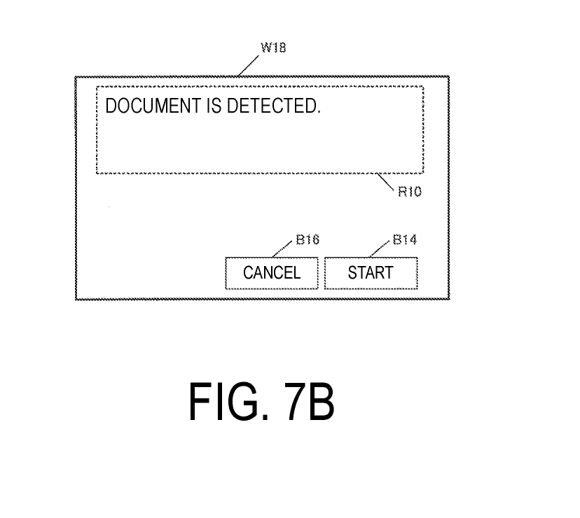

Next, FIG. 7A illustrates an example of a configuration of a notification screen W16 as the third notification screen displayed in step S26 of FIG. 3. The notification screen W16 may have substantially the same configuration as the notification screen W12.

The notification content display region R10 is a display region for displaying the notification content indicated as a notification on the notification screen W16. On the notification screen W16 as the third notification screen, the controller 11 displays a warning indicating that the print output with the sheet of the maximum size is performed, that is, "Document size is not detected. If you select "start", printing is performed on a sheet of maximum size." as the notification content in the notification content display region R10.

FIG. 7B illustrates an example of a configuration of a notification screen W18 as the notification screen displayed in step S32 of FIG. 3. The notification screen W18 may have substantially the same configuration as the notification screen W12.

The notification content display region R10 is a display region for displaying the notification content indicated as a notification on the notification screen W18. In the notification screen W18, the controller 11 displays a notification indicating that a document is detected, that is, "Document is detected." as the notification content in the notification content display region R10.

As described above, according to the first embodiment, when an instruction to execute a job such as copying is received in a state where a size of a document is not set by a user and the size of the document that can be detected by the detector is not detected, the notification screen related to the detection of the document can be displayed depending on the operation history of the user or the apparatus status of the image reading apparatus. With the configuration like this, it is possible to restrict the warning to the user more than necessary and to avoid interference with the user's operation.

Further, according to the first embodiment, it is possible to lead the user to perform an appropriate operation when the document (size) is not detected, which allows the user to be conscious of an operation for an unnecessary warning to be not displayed.

### 2 Second Embodiment

In the second embodiment, user information (authentication information) and an operation record of the user (also referred to as an authenticated user) are managed in association with each other, and display of a notification screen related to detection of a document is controlled.

### 2.1 Functional Configuration

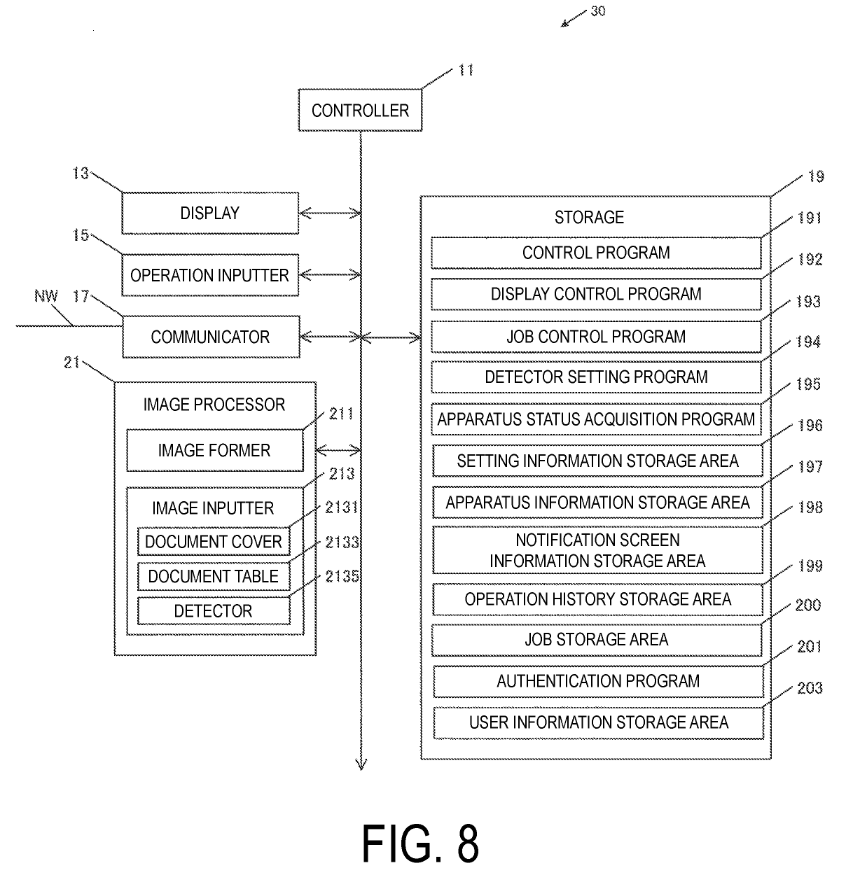

FIG. 8 is a functional configuration diagram of a multifunction peripheral 30 as an image reading apparatus according to the second embodiment. The multifunction peripheral 30 according to the second embodiment stores an authentication program 201 and secures a user information storage region 203 in addition to the configuration of the multifunction peripheral 10 according to the first embodiment.

The authentication program 201 is a program that the controller 11 reads when authenticating a user who attempts to log in to the multifunction peripheral 30. The controller 11 having read the authentication program 201 serves as an authenticator to display a login screen not illustrated on the display 13 when a user authentication function is enabled and receive input of a login name and a login password, for example. The controller 11 can authenticate the user by storing the login names and login passwords related to the user authentication in association with each other in advance in the user information storage region 203 and checking the login name and the login password input via the login screen against the stored login user names and login passwords. Note that the login authentication may be, for example, possession-based authentication using a token, a key, an integrated circuit (IC) card, or a smartphone, or biometric authentication such as face authentication or fingerprint authentication, in addition to knowledge-based authentication based on the input of a login name and a login password. Note that the controller 11 can switch the user authentication between enabled and disabled based on setting content set via a setting screen not illustrated. Here, the authenticator may use, for example, an external authentication server or the like as an authentication destination of a user who attempts to log in, in addition to a main body of the multifunction peripheral 30.

The user information storage region 203 is a storage region for storing the user authentication information. Here, an example of the user information stored in the user information storage region 203 is described with reference to FIG. 12B.

FIG. 12B is an example of a configuration of a user information management table 2031 for managing the user information. Note that the user information is not limited to a table format, and may be managed in a database format.

The user information management table 2031 includes, as management items of the user information, an ID, a user name, a login name, a login PW, authority, and a count of displaying the notification screen. The ID is an identifier for uniquely identifying a user. The user name represents a name of a user. The login name represents a login user name of a user who logs in the multifunction peripheral 30, and the login PW represents a login password set for the login name. The authority represents an operation authority for the multifunction peripheral 30. The count of displaying the notification screen represents a count of displaying the notification screen or the like including the warning indicating that the document size is undetected, which is displayed for the user identified by the user name.

For example, for a user having a user name "User_01 " identified by an ID "#003", a login name "aaaaa", a login PW "a12345", and an operation authority "administrator" for the multifunction peripheral 30 are set. Here, for the relevant user, indicated is that the notification screen is not displayed ("0" times).

On the other hand, for a user having the user name "User_03" identified by the ID "#007", the login name "ccccc", the login PW "b34567", and the operation authority "general" for the multifunction peripheral 30 are set. Here, for the relevant user, indicated that the notification screen is displayed "10" times.

### 2.2 Processing Flow

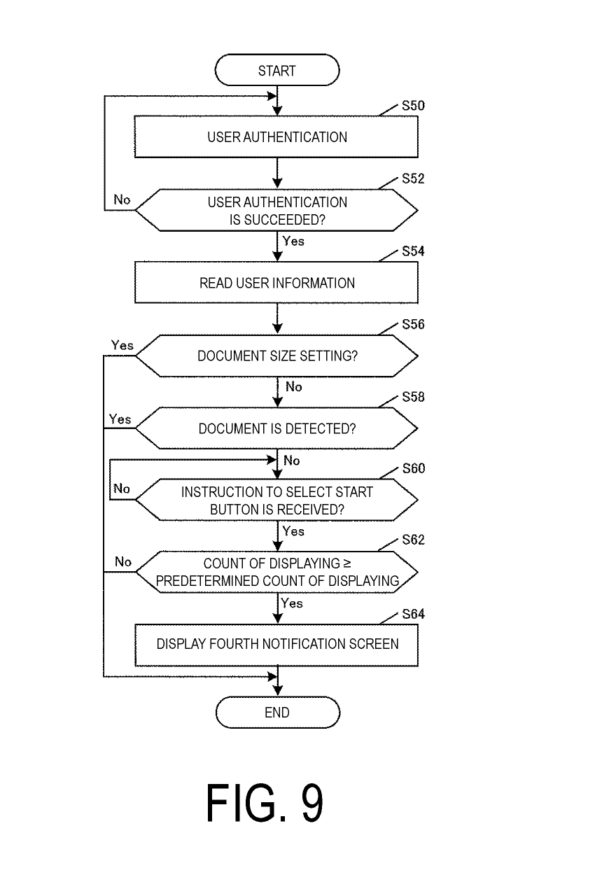

Next, a processing flow according to the second embodiment is described with reference to the flowchart illustrated in FIG. 9. The processing described in FIG. 9 is executed by the controller 11 of the multifunction peripheral 30 reading the control program 191, the display control program 192, the job control program 193, the detector control program 194, the apparatus status acquisition program 195, the authentication program 201, and the like.

At a timing such as when the power of the multifunction peripheral 30 is turned on, the controller 11 displays a login screen not illustrated on the display 13 and performs the user authentication by receiving the input of a login name and a login password (step S50).

The controller 11 performs the user authentication by checking the login name and login password input by the user against the user information management table 2031 illustrated in FIG. 12B. When determining that the authentication has succeeded, the controller 11 reads the user information such as the authority of the user and the count of displaying the notification screen from the user information management table 2031 (step S52; Yes -> step S54). On the other hand, when determining that the user authentication has failed, the controller 11 repeats the processing from step S50 (step S52; No -> step S50).

Then, the controller 11 determines whether the setting of the document size is made for the document placed on the document table 2133 to be read (step S56).

When determining that the setting of the document size is made, the controller 11 ends the processing (step S56; Yes -> end). On the other hand, when determining that the setting of the document size is not made, the controller 11 determines whether the document (document size) is detected by the detector 2135 (step S56; No -> step S58).

When determining that the document (document size) is detected by the detector 2135, the controller 11 ends the processing (step S58; Yes -> end). On the other hand, when determining that the document (document size) is not detected by the detector 2135, the controller 11 determines whether an instruction to select the start button by the user is received (step S58; No -> step S60).

When determining that the instruction to select the start button by the user is received, the controller 11 determines whether the count of displaying the notification screen to the user read in step S54 is equal to or greater than a predetermined count of displaying (step S60; Yes -> step S62). On the other hand, when determining that the instruction to select the start button by the user is not received, the controller 11 waits until the instruction to select the start button is received (step S60; No).

When determining that the count of displaying the notification screen to the user is equal to or more than the predetermined count of displaying, the controller 11 displays the fourth notification screen including a factor that causes the document to be undetected (the operation content for which a warning may be displayed), and ends the processing (step S62; Yes -> step S64 -> end). On the other hand, when determining that the count of displaying the notification screen to the user is less than the predetermined count of displaying, the controller 11 ends the processing (step S62; No -> end).

Here, for example, if the predetermined count of displaying is set to "3" (times), the user name "User_02" exemplified in FIG. 12B does not satisfy the requirement of the step S62 because the count of displaying the notification screen is "2" (times). Therefore, the processing of the step S64 is omitted for the user name "User_02". On the other hand, the user name "User_03" satisfies the requirement of the step S62 because the count of displaying the notification screen is "10" (times). Therefore, the processing of step S64 is executed for the user name "User_03", and the fourth notification screen including the factor causing the document to be undetected (the operation content for which a warning may be displayed) is displayed.

Note that as in the example of the user name "User_03", when the notification screen (warning) is displayed with high frequency for a specific authenticated user, the administrator may be contacted and caused to lead the relevant authenticated user to an operation in which the notification screen (warning) is not displayed.

### 2.3 Operation Example

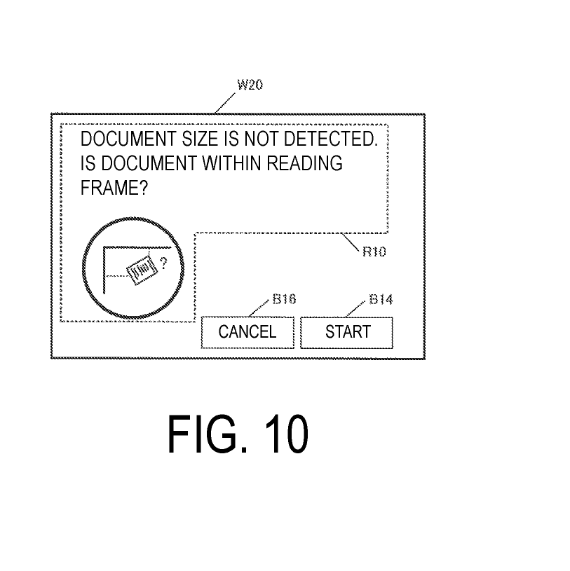

Next, an operation example according to the second embodiment is described. FIG. 10 is an example of a configuration of a notification screen W20 as the fourth notification screen including the factor causing the document to be undetected (the operation content for which a warning may be displayed). The notification screen W20 may have substantially the same configuration as the notification screen W12.

The notification content display region R10 is a display region for displaying the notification content indicated as a notification on the notification screen W20. On the notification screen W20 as the fourth notification screen, the controller 11 displays, as an example of the factor causing the document to be undetected, "The document size is not detected. Is the document within the reading frame?" as the notification content in the notification content display region R10. As illustrated in FIG. 10, in the notification content display region R10, image information related to the factor causing the document to be undetected may be displayed in addition to the text information related to the factor causing the document to be undetected, but only the text information may be displayed. Further, the notification content displayed in the notification content display region R10 may be changed depending on the operation history of the specific authenticated user. For example, when the fact that the opening/closing operation of the document cover 2131 is sensed is stored as the operation history of the specific authenticated user, a message may be displayed that "The document size is not detected. Is the document within the reading frame?" as the notification content in the notification content display region R10, as illustrated in FIG. 10. On the other hand, when the fact that the opening/closing operation of the document cover 2131 is sensed is not stored as the operation history of the specific authenticated user, a message may be displayed that "The document size is not detected. Do you leave the document on the document table?" as the notification content in the notification content display region R10.

As described above, according to the second embodiment, in addition to the effect of the first embodiment, when the count of displaying the notification screen for the specific authenticated user is equal to or more than the predetermined count of displaying, that is, when the notification screen (warning) is displayed with high frequency for the specific authenticated user, the specific authenticated user can be made conscious of a countermeasure for preventing the notification screen (warning) from being displayed by indicating the factor causing the document to be undetected to the specific authenticated user.

### 3 Third Embodiment

In the third embodiment, when the notification screen (warning) is displayed with high frequency for the specific authenticated user, the display of the notification screen is controlled depending on whether the start button/cancel button is selected after the notification screen (warning) is displayed.

Since a functional configuration of a multifunction peripheral according to the third embodiment can be substantially the same configuration as the functional configuration of the multifunction peripheral 30 according to the second embodiment, description thereof is omitted here.

### 3.1 Processing Flow

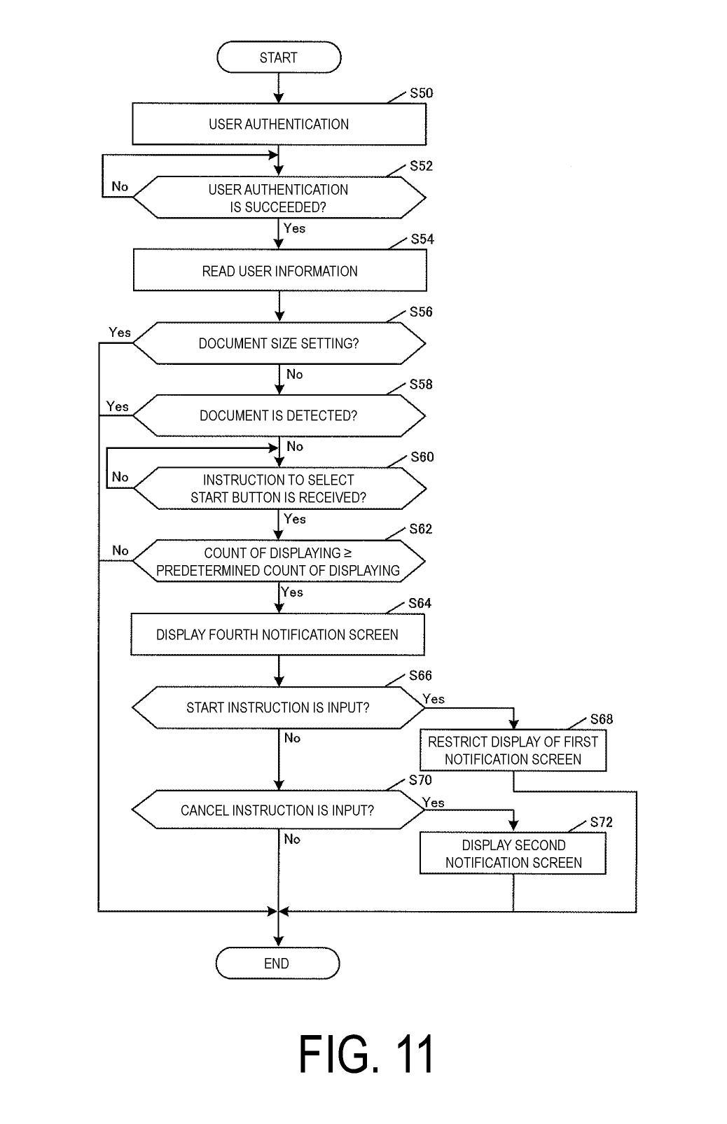

Next, a processing flow according to the third embodiment is described with reference to the flowchart of FIG. 11. The processing described with reference to FIG. 11 is processing continued from step S64 in FIG. 9 according to the second embodiment. Therefore, the description of the processing up to step S64 is omitted.

After displaying the fourth notification screen, the controller 11 determines whether an instruction to select the start button by the user is received (step S64 -> step S66). When determining that the instruction to select the start button by the user is received, the controller 11 restricts the display of the first notification screen and ends the processing (step S66; Yes -> step S68 -> end).

Here, when determining that the instruction to select the start button by the user is not received, the controller 11 determines whether an instruction to select the cancel button is received (step S66; No -> step S70). When determining that the instruction to select the cancel button by the user is received, the controller 11 displays the second notification screen and ends the processing (step S70; Yes -> step S72 -> end). On the other hand, when determining that the instruction to select the cancel button by the user is not received, the controller 11 ends the processing (step S70; No -> end).

As described above, according to the third embodiment, in addition to the effects of the second embodiment, when the notification screen (warning) is displayed with high frequency for the specific authenticated user, the display of the notification screen is controlled depending on whether the start button/cancel button is selected after the notification screen (warning) is displayed. When the start button is selected even though the notification screen (warning) is displayed, it is highly possible that the specific authenticated user ignores the warning (the warning to the specific authenticated user is not necessary), and thus the first notification screen including the warning indicating that the document size is not detected can be prevented from being displayed. On the other hand, when the cancel button is selected after the notification screen (warning) is displayed, it is highly possible that the specific authenticated user confirms the setting of the document size based on the warning, and thus the second notification screen including the warning prompting the user to change the document setting can be displayed.

The disclosure is not limited to the above-described embodiments, and various modifications are possible. In other words, the technical scope of the disclosure also includes embodiments obtained by combining technical means that are appropriately modified within the scope of the gist of the disclosure.

Further, although the above-described embodiments are described separately for convenience of description, it is obvious that the embodiments may be executed in combination within a technically possible scope.

Further, in the embodiments, a program operating on each apparatus is a program that controls a CPU or the like (a program for causing a computer to function) to realize the functions of the above-described embodiments. Information handled by such an apparatus is temporarily stored in a temporary storage apparatus (for example, a RAM) during processing and then stored in various storage apparatuses such as read only memories (ROMs) and HDDs, and is read, modified, and written by the CPU as necessary.

Here, a computer-readable non-transitory recording medium on which the program is recorded in the information processing apparatus may be any of a semiconductor medium (for example, a ROM or a non-volatile memory card), an optical recording medium/magnetic optical recording medium (for example, a digital versatile disc (DVD), magneto optical disc (MO), mini disc (MD), compact disc (CD), Blu-ray (BD; registered trademark) disc), or the like), a magnetic recording medium (for example, a magnetic tape or flexible disk), and the like. In this case, the program recorded on the recording medium is read by the computer of the information processing apparatus and executed by the computer, such that not only the functions of the above-described embodiment are realized, but also functions of the disclosure are realized by performing processing in cooperation with an operating system, another application program, or the like based on instructions of the program.

Further, when a program is distributed in the market, the program can be stored in a portable recording medium and distributed, or can be transferred to a server computer connected via a network such as the Internet. In this case, it is obvious that a storage apparatus of the server computer is also included in the disclosure.

Further, each functional block or feature of the apparatus used in the above-described embodiment can be implemented and executed by an electric circuit, such as an integrated circuit or a plurality of integrated circuits. The electric circuit designed to realize the functions described herein may include a general-purpose processor, a digital signal processor (DSP), an application-specific integrated circuit (ASIC), a field programmable gate array (FPGA), another programmable logic device, a discrete gate or transistor logic, a discrete hardware component, or a combination thereof. The general-purpose processor may be a microprocessor, or any known processor, controller, microcontroller, or state machine. The electric circuit described above may be configured of a digital circuit or may be configured of an analog circuit. Further, when an integrated circuit technology for replacement into a current integrated circuit emerges with the development of semiconductor technology, a new integrated circuit based on the technology may also be used in one or more aspects of the disclosure.

### DESCRIPTION OF SYMBOLS

10, 30 Multifunction peripheral

11 Controller

13 Display

15 Operation inputter

17 Communicator

19 Storage

21 Image processor

211 Image former

213 Image inputter

2131 Document cover

2133 Document table

2135 Detector

1. An image reading apparatus that executes a job involving reading of a document, the image reading apparatus comprising:
a detector capable of detection of the document placed on a document table; and
one or more controllers that control display of a notification screen related to the detection of the document, wherein
the one or more controllers control display of a first notification screen related to the detection of the document, depending on an operation history of a user or an apparatus status of the image reading apparatus, when an instruction to execute a job is received, if a size of the document is not set and the document is not detected by the detector.

2. The image reading apparatus according to claim 1, further comprising: a cover member formed to be openable and closable with respect to the document table; and a storage, wherein the one or more controllers display a second notification screen different from the first notification screen, when the operation history of the user indicating an opening or closing operation of the cover member is stored in the storage.

3. The image reading apparatus according to claim 1, wherein the one or more controllers restrict the display of the first notification screen, when the one or more controllers determine, as the apparatus status of the image reading apparatus, that sheets having the same size are accommodated in all sheet feed trays mounted in the image reading apparatus.

4. The image reading apparatus according to claim 1, wherein the one or more controllers display a third notification screen different from the first notification screen, when the one or more controllers determine, as the apparatus status of the image reading apparatus, that the sheet feed trays mounted in the image reading apparatus include a sheet feed tray accommodating a sheet having a maximum size that the image reading apparatus is capable of handling.

5. The image reading apparatus according to claim 1, further comprising: an authenticator that authenticates the user based on authentication information; and a storage, wherein the one or more controllers store, in the storage, the authentication information of the authenticated user authenticated by the authenticator and a count of displaying the notification screen to the authenticated user in association with each other, and display a fourth notification screen different from the first notification screen, when the count of displaying exceeds a predetermined count of displaying.

6. The image reading apparatus according to claim 5, wherein the one or more controllers display a factor of undetection of the document in display content of the fourth notification screen.

7. The image reading apparatus according to claim 1, wherein the one or more controllers display a notification screen having a display content indicating that the document is detected, when the document is detected by the detector.

8. A control method of an image reading apparatus, the image reading apparatus including a detector capable of detection of a document placed on a document table and executing a job involving reading of the document, the control method comprising: controlling display of a notification screen related to the detection of the document, depending on an operation history of a user or an apparatus status of the image reading apparatus, when an instruction to execute a job is received, if a size of the document is not set and the document is not detected by the detector.
